(19) United States
(12) Patent Application Publication
(10) Pub. No.: US 2025/0027817 A1
(43) Pub. Date: Jan. 23, 2025

(54) DEVICE FOR DETECTING THE PASSAGE OF AN INFRARED RADIATION EMITTING BODY IN A MONITORING ZONE, AND RELATED METHOD

(71) Applicant: STMicroelectronics International N.V., Geneva (CH)

(72) Inventors: Carlo GUADALUPI, Sedriano (IT); Stefano Paolo RIVOLTA, Desio (IT); Mauro BARDONE, Cava Manara (IT); Andrea LABOMBARDA, Milano (IT)

(73) Assignee: STMicroelectronics International N.V., Geneva (CH)

(21) Appl. No.: 18/759,045

(22) Filed: Jun. 28, 2024

(30) Foreign Application Priority Data
Jul. 21, 2023 (IT) 102023000015414

(51) Int. Cl. G01J 5/00; G01J 5/07; G01J 5/20

(52) U.S. Cl. CPC G01J 5/0025; G01J 5/07; G01J 5/20

(57) ABSTRACT

The present disclosure is directed to a device for detecting the passage of an infrared, IR, radiation emitting body in a monitoring zone. The device has a first surface and a second surface mutually tilted and configured to face the monitoring zone. The device includes a first IR radiation sensor extending on the first surface and a second IR radiation sensor extending on the second surface. The first IR radiation sensor is configured to detect the IR radiation of the emitting body when the emitting body is in a first field of view of the first IR radiation sensor and the second IR radiation sensor is configured to detect the IR radiation of the emitting body when the emitting body is in a second field of view of the second IR radiation sensor. The first and the second fields of views are configured to be partially superimposed on each other at the monitoring zone.

### BACKGROUND

### Technical Field

The present disclosure relates to a device for detecting the passage of an infrared radiation emitting body in a monitoring zone, and to a related method for detecting the passage of the emitting body in the monitoring zone.

### Description of the Related Art

As known, the need to detect the passage of people in certain zones is commonly felt. For example, it may be required to detect the passage of people through a door leading to a room, so as to monitor the number of people present in the room (e.g., for safety reasons in places such as operating theaters and stadiums or for organizational and control reasons in places such as public transportation means and meeting rooms). This is useful for applications such as automatic control in a lighting or heating room (i.e., automatic turn on and off of lights/heating/air conditioning in the room as a function of the people possibly present therein) and monitoring of the number of people in closed environments or environments that have specific safety requirements related to the maximum number of people that they can contain (e.g., operating theaters and stadiums).

To achieve this aim, it is often required to be capable of monitoring the passage direction of the person transiting through the monitoring zone and therefore not only his/her passage in the latter, so as to be capable of determining, for example, whether the person is entering or leaving the room.

Some solutions are known which allow the passage of people in monitoring zones to be detected.

Most of these solutions are based on optical technology and in particular use a light radiation transmitter and receiver which are placed at ends opposite to each other of the monitoring zone, in such a way that the passage of a person through the monitoring zone causes the interruption of a light beam (e.g., of infrared, IR, type) emitted by the transmitter and received by the receiver in the absence of the person. This interruption of the light beam is therefore indicative of the passage of the person in the monitoring zone. However, this type of known solutions has several disadvantages: it requires a large quantity of electrical circuits for controlling both the emitter and the receiver, it is not capable of selectively recognizing the human body (i.e., even a non-emitting body such as an inanimate object placed in the monitoring zone might interrupt the light beam and generate false positives), it is very expensive and requires accurate mounting and calibration of the emitter and the receiver in order to operate.

Furthermore, the known solutions are generally not capable of detecting the passage direction of the person but only his/her passage in the monitoring zone, therefore they do not allow a high measurement accuracy of the number of people in the environment to be monitored.

Various embodiments of the present disclosure provide a device for detecting the passage of an infrared radiation emitting body in a monitoring zone and a related method for detecting the passage of the emitting body in the monitoring zone, which overcome the drawbacks of the prior art.

### BRIEF SUMMARY

According to the present disclosure a device for detecting the passage of an infrared radiation emitting body in a monitoring zone and a related method for detecting the passage of the emitting body in the monitoring zone are provided.

The device has a first surface and a second surface mutually tilted and configured to face the monitoring zone. The device includes a first IR radiation sensor extending on the first surface and a second IR radiation sensor extending on the second surface. The first IR radiation sensor is configured to detect the IR radiation of the emitting body when the emitting body is in a first field of view of the first IR radiation sensor and the second IR radiation sensor is configured to detect the IR radiation of the emitting body when the emitting body is in a second field of view of the second IR radiation sensor. The first and the second fields of views are configured to be partially superimposed on each other at the monitoring zone.

### BRIEF DESCRIPTION OF THE SEVERAL VIEWS OF THE DRAWINGS

For a better understanding of the present disclosure, embodiments are now described, purely by way of non-limiting example, with reference to the attached drawings, wherein:

FIG. 1 shows a schematic top-view of two environments connected by a passageway with a monitoring zone wherein a device for detecting the passage of an infrared radiation emitting body is present, according to an embodiment;

FIG. 2 shows in detail the device of FIG. 1, according to an embodiment;

FIGS. 3 and 4 are plots showing electric signals generated by infrared radiation sensors comprised in the device of FIG. 2, according to respective embodiments; and

FIG. 5 is a block diagram schematically showing a method for detecting the passage of the infrared radiation emitting body in the monitoring zone, according to an embodiment.

In particular, the Figures are shown with reference to a triaxial Cartesian system defined by an axis X, an axis Y and an axis Z, which are orthogonal to each other.

In the following description, elements common to the different embodiments have been indicated with the same reference numerals.

### DETAILED DESCRIPTION

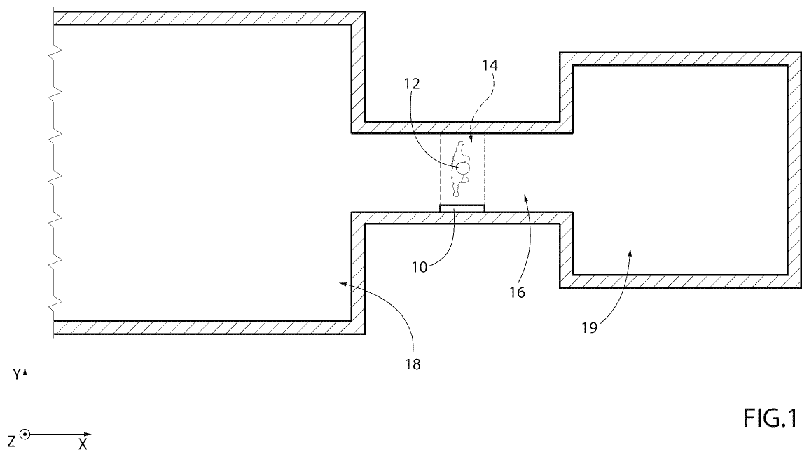

FIG. 1 shows a device (or sensor device) 10 for detecting the passage of a person 12 in a monitoring zone 14.

In detail, the monitoring zone 14 is a passage region which connects a first environment 18 with a second environment 19, through which the person 12 has to transit to pass from the first to the second environment 18, 19 and vice versa.

In greater detail and for the reasons better discussed below, the first environment 18 and the second environment 19 are considered to communicate with each other through the monitoring zone 14, i.e., the passage between the first environment 18 and the second environment 19 occurs through the monitoring zone 14, so that whoever wants to pass from one of the two environments 18, 19 to the other can do so by transiting through the monitoring zone 14. Nevertheless, this may not be true in other embodiments.

In the embodiment exemplarily shown in FIG. 1, the monitoring zone 14 is a part of a corridor 16 (or it is a door) which connects the second environment 19, here a room in a building, to the first environment 18, here an outer environment (or a different room in the building). In other words, the room 19 is accessible for the person 12, who is in the outer environment 18, just by passing through the monitoring zone 14.

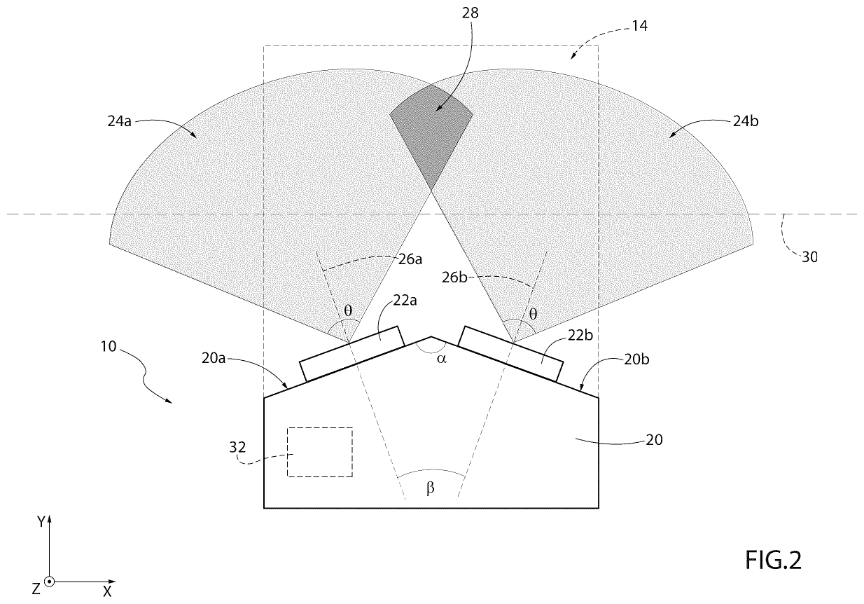

FIG. 2 shows the device 10 in more detail, in particular in a plane XY defined by the axes X and Y.

The device 10 comprises a main body or substrate 20 having a first surface 20a and a second surface 20b facing the monitoring zone 14 and tilted to each other. In one embodiment, as shown in FIG. 2, the first surface 20a and the second surface 20b are directly connected to each other and form a continuous surface.

In detail, the first surface 20a and the second surface 20b are outer surfaces of the main body 20 and, for example, are adjacent to each other (i.e., share a part of their outer edges).

The first surface 20a and the second surface 20b are fixed to each other in a predetermined angular position.

In detail, the first surface 20a and the second surface 20b have a first tilting angle α therebetween. For example, the first tilting angle α is measured in the plane XY between the first surface 20a and the second surface 20b, inside the device 10 (e.g., extending through the main body 20). In other words, the first tilting angle α is the smaller angle of the two explementary angles formed by the intersection of the first surface 20a and the second surface 20b.

In particular, the first tilting angle α is determined in the design step on the basis of parameters better described below.

According to an exemplary embodiment, the first tilting angle α is comprised between about 110° and about 170°.

The device 10 further comprises a first infrared, IR, radiation sensor 22a and a second IR radiation sensor 22b.

The first and the second IR radiation sensors are infrared radiation sensors, in particular devices of MEMS type. Consequently, the first and the second IR radiation sensors are made through various micromanufacturing techniques for processing semiconductor materials, such as for example silicon.

The first and the second IR radiation sensors 22a and 22b are carried by the main body 20 and extend respectively on the first and the second surfaces 20a and 20b, in such a way as to be also tilted to each other by the first tilting angle α.

In greater detail, the first and the second IR radiation sensors 22a and 22b respectively have a first field of view (FoV) 24a and a second field of view 24b. When the person 12 is in one of these fields of view 24a, 24b, the respective IR radiation sensor 22a, 22b is capable of detecting the IR radiation emitted by the person 12 and therefore the presence of the person 12 in the respective field of view 24a, 24b.

Each field of view 24a, 24b substantially has an axial symmetry with respect to a respective detection direction 26a, 26b of the first and the second IR radiation sensors 22a and 22b. These detection directions 26a, 26b are substantially orthogonal respectively to the first and the second surfaces 20a and 20b and define a second tilting angle β therebetween which is supplementary with respect to the first tilting angle α.

In particular, here field of view means the volume, i.e., the portion of three-dimensional space, wherein the person 12 may stand so that the IR radiation emitted thereby is detected by the respective IR radiation sensor. In particular, the field of view has a substantially conical shape defined by an opening angle θ and a field length, measured along the respective detection direction, which are defined in the design step of the IR radiation sensor (e.g., they depend on the presence or absence of directional lenses, on optical and physical parameters of the same and the detectors used, etc.). In general, as the opening angle θ increases, the field length decreases, and vice versa.

For example, the field of view 24a, 24b are substantially equal to each other, i.e., the respective opening angles θ and the respective field lengths are substantially equal to each other.

According to one embodiment, the opening angle θ of the fields of view 24a, 24b is comprised between about 40° and about 110°. Furthermore, the field length of the fields of view 24a, 24b may be comprised between about 50 cm and about 4 m.

As shown in FIG. 2, the fields of view 24a, 24b of the IR radiation sensors 22a, 22b are partially superimposed on each other, i.e., they have a mutual superimposition region (or volume) 28 which is common to both fields of view 24a, 24b. In detail, the fields of view 24a, 24b are partially superimposed on each other.

According to an exemplary embodiment, the mutual superimposition region 28 is smaller by about 80% of each of the first and the second fields of view, and in particular is equal to about 20% of the first and the second fields of view (here considered substantially with the same extension).

In particular, the first tilting angle α between the first and the second surfaces 20a and 20b and the parameters of the fields of view 24a, 24b (i.e., the opening angle θ and the field length) are chosen in the design step of the device 10 in such a way as to ensure the partial superimposition of the fields of view 24a, 24b, and in particular the previously described relatively small values of the mutual superimposition region 28.

Furthermore, the mutual superimposition region 28 of the fields of view 24a, 24b extends at the monitoring zone 14.

In detail, the fields of view 24a, 24b (and, in particular, the mutual superimposition region 28) extend at the monitoring zone 14, for example in such a way as to cover the entire, or almost the entire, monitoring zone 14.

In general, the device 10 is designed and arranged in such a way that, when the person 12 passes in the monitoring zone 14, the person 12 traverses in succession to each other the fields of view 24a, 24b of the IR radiation sensors 22a, 22b.

In other words, when the person 12 transits in the monitoring zone 14, he/she substantially follows a passage direction 30 which traverses the monitoring zone 14 and which, in the exemplary embodiment of FIG. 2, is shown parallel to the axis X. The device 10 is oriented in such a way that the passage direction 30 traverses both fields of view 24a, 24b, in particular also in parts of the fields of view 24a, 24b which are not superimposed on each other (i.e., which are laterally staggered from each other, i.e., staggered along the passage direction 30).

Since the fields of view 24a, 24b of the IR radiation sensors 22a, 22b extend laterally to each other and in succession along the passage direction 30, the passage of the person 12 through the monitoring zone 14 along the passage direction 30 is detected by both IR radiation sensors 22a, 22b in succession to each other.

In particular, the device 10 and its arrangement relative to the monitoring zone 14 are designed and formed in such a way that the monitoring zone 14 is entirely covered by fields of view 24a, 24b in a direction orthogonal to the passage direction 30. In other words, each of the fields of view 24a, 24b is superimposed on the monitoring zone 14 along the entire extension, orthogonally to the passage direction 30, of the monitoring zone 14. In this manner, the person 12 who traverses the monitoring zone 14 parallel to the passage direction 30 necessarily passes through both fields of view 24a, 24b.

For example, if the person 12 passes from the first to the second environment 18, 19 and therefore moves, in the example of FIG. 2, from left to right along the passage direction 30, the IR radiation emitted by the person 12 is detected in a first time period by the first IR radiation sensor 22a (not by the second IR radiation sensor 22b) and in a second time period by the second IR radiation sensor 22b (not by the first IR radiation sensor 22a). In an intermediate time period comprised between the first and the second time periods, the IR radiation emitted by the person 12 may also be detected simultaneously by both IR radiation sensors 22a and 22b (because the person 12 is in the mutual superimposition region 28), however the information relating to the passage may in any case be acquired on the basis of the IR radiation detected in the first and in the second time periods.

As better described below, this allows to determine both when the passage of the person 12 through the monitoring zone 14 occurs and the direction of this passage (i.e., whether from the first environment 18 towards the second environment 19 or vice versa).

In greater detail, the first and the second IR radiation sensors 22a and 22b are based on “Thermal MOS,” TMOS (Thermal Metal-Oxide-Semiconductor), technology, i.e., they each comprise a respective TMOS which functions as a detector of the IR radiation emitted by the person 12.

In particular, the TMOS is a field effect transistor device and typically used in sensor applications to determine the amount of radiation (in detail IR radiation) emitted by an emitting object, here the person 12. The emitting body is any hot body that emits IR radiation, such as a person or animal. The radiation, emitted by the emitting body and received by the TMOS, causes the generation of charge carriers at the conductive channel of the TMOS and, therefore, a corresponding variation of the output current of the TMOS; the latter may be related to the extent of the radiation emitted by the object under examination, in such a way as to have a measure of the radiation emitted by the emitting body. In detail, the detection of the IR radiation by the TMOS occurs when the emitting body is in the field of view of the TMOS.

In general, the TMOS allows the presence or absence of the emitting body to be detected in its field of view.

According to an embodiment exemplarily considered below, the TMOS present in the device are the Infrared Temperature Sensor TMOS marketed by STMicroelectronics with, for example, the reference code STHS34PF80 (further details may be found at the address https://www.st.com/en/mems-and-sensors/infrared-ir-sensors.html).

In particular, the TMOS (e.g., STMicroelectronics' STHS34PF80) are each capable of generating at least one temperature signal and one motion signal, both correlated to the presence or absence of the emitting body in the field of view.

The temperature signal is a signal indicative of the temperature of the entities (living beings such as people or inanimate but hot objects such as heating appliances) present in the field of view of the TMOS.

Consequently, the temperature signal is determined as a function of both the IR radiation emitted by an emitting body present in the field of view of the TMOS, and the IR radiation which may normally be present in the environment wherein the TMOS is placed even in the absence of living beings. In other words, the temperature signal has a baseline which depends on the amount of environmental IR radiation that the TMOS measures in the absence of the person in the field of view (e.g., due to electromagnetic noise of the environment wherein the TMOS is present, at the temperature of the air surrounding the TMOS, etc.), and may vary with respect to this baseline when the TMOS detects the IR radiation emitted by the emitting body, which sums to the environmental IR radiation already present. Consequently, peaks of the temperature signal of the TMOS with respect to its baseline are indicative of the person's presence in the field of view of the TMOS.

In the embodiment here considered wherein the TMOS are the STMicroelectronics' STHS34PF80, the temperature signal corresponds to the signal T_{object} (or also T_{obj}) indicated in the datasheet of the TMOS. For this reason, hereinafter the temperature signal is indicated with the reference T_{object}.

Conversely, the motion signal is a signal indicative of a variation over time of the temperature of the environment wherein the TMOS is present, i.e., the temperature of the entities (living beings such as people or inanimate but hot objects such as heating apparatuses) present in the field of view of the TMOS. In other words, the motion signal is a signal correlated to the variation over time of the temperature signal.

In particular, the motion signal is generated starting from the temperature signal. For example, the temperature signal is filtered with a first and with a second low-pass filter (e.g., considering an “output data rate” ODR, of the TMOS, the first filter has a cut-off frequency equal to about ODR/9 and the second filter has a cut-off frequency equal to about ODR/20) to obtain respective filtered temperature signals and the motion signal is obtained as a function of a difference, in absolute value, of these filtered temperature signals.

Consequently, the motion signal has an approximately zero value when no emitting body is transiting through the field of view, and has a peak whenever the passage of the emitting body in the field of view occurs. In other words, the motion signal is correlated to input and output transient events of the emitting body in the field of view.

In the embodiment here considered wherein the TMOS are the STMicroelectronics' STHS34PF80, the motion signal corresponds to the signal Tₘₒₜᵢₒₙ indicated in the datasheet of the TMOS. For this reason, hereinafter the motion signal is indicated with the reference Tₘₒₜᵢₒₙ.

For example, in the present application the two TMOS may function with the ODR equal to about 8 Hz.

With reference again to FIG. 2, the device 10 further comprises a control unit 32, for example accommodated in the main body 20, which is coupled (in detail, electrically coupled) to the first and the second IR radiation sensors 22a and 22b. The control unit 32 may any type of circuitry (e.g., processor, controller, signal processor, etc.) that processes data.

In use, the control unit 32 receives a first detection signal from the first IR radiation sensor 22a and a second detection signal from the second IR radiation sensor 22b. The first and the second detection signals may be respective temperature signals T_{object} or respective motion signals Tₘₒₜᵢₒₙ. In both cases, the first and the second detection signals are indicative of the presence or absence of the person 12 in the first and the second fields of view 24a and 24b, respectively.

Furthermore, the control unit 32 determines, on the basis of the first and the second detection signals, whether the passage of the person 12 in the monitoring zone 14 has occurred.

To do this, the control unit 32 verifies whether the first and the second detection signals respectively have a first signal peak and a second signal peak within a passage time interval and confirms the passage of the person 12 in the monitoring zone 14 if the first and the second detection signals have the first signal peak and the second signal peak in the passage time interval. In detail, the passage time interval is measured starting from the first of the first signal peak and the second signal peak, i.e., from the peak (the first signal peak or the second signal peak) which has been detected first.

The passage time interval is a predefined time interval whose duration is established in the design step in a per se obvious manner on the basis of factors such as the distance that the person 12 travels to traverse the fields of view in the monitoring zone 14, the average walking speed of the person 12, etc. For purely exemplary purposes, the passage time interval may be equal to about 5 seconds. For example, the passage time interval is measured starting from the rising edge of the first peak detected of the pair of peaks which are indicative of the passage of the person 12 in the monitoring zone 14.

In particular, the detection of the first signal peak and the second signal peak occurs in a different manner depending on whether the control unit 32 processes the temperature signals T_{object} or the motion signals Tₘₒₜᵢₒₙ to determine the passage of the person 12. This occurs due to the fact that the motion signals Tₘₒₜᵢₒₙ have a zero baseline while the temperature signals T_{object} usually have a non-zero baseline and generally a baseline that is different from each other.

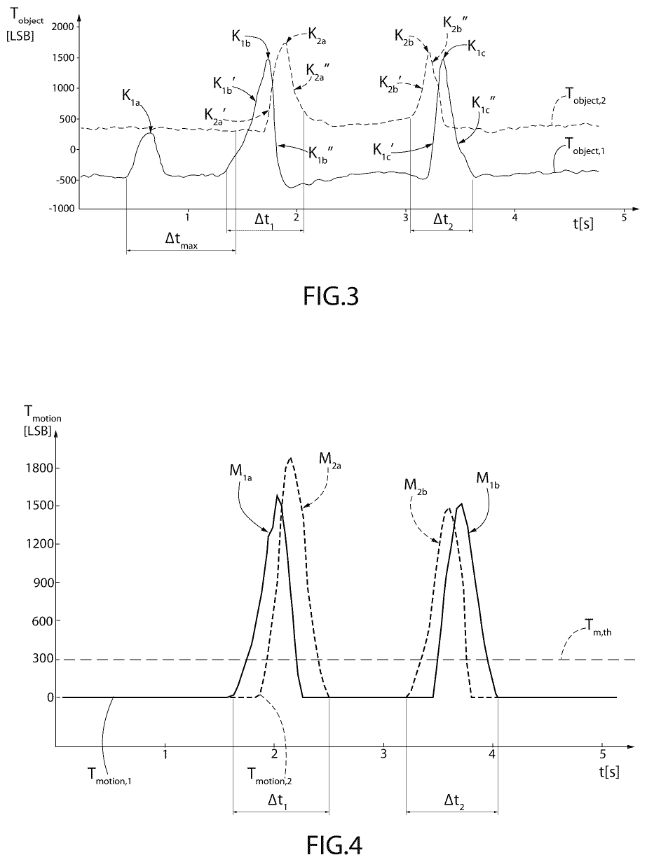

The case in which the first and the second detection signals acquired by the control unit 32 are temperature signals T_{object} is now described with reference to FIG. 3.

In detail, FIG. 3 shows the trend over time of the temperature signals T_{object} detected by the first and the second IR radiation sensors 22a and 22b. Hereinafter, the temperature signal T_{object} detected by the first IR radiation sensor 22a is also called first temperature signal T_{object,1} and the temperature signal T_{object} detected by the second IR radiation sensor 22b is also called second temperature signal T_{object,2}.

In the example of FIG. 3, the case in which a false passage (i.e., an isolated peak of one of the temperature signals T_{object} which, however, is not indicative of a real passage of the person 12 in the monitoring zone 14) followed by two passages of the person 12 in the monitoring zone 14 occur in succession to each other is exemplarily considered, the first passage relating to the person 12 who transits from the first to the second environment 18, 19 and the second passage relating to the person 12 who transits from the second to the first environment 19, 18.

In greater detail, as time progresses, the first temperature signal T_{object,1} has a first peak K₁ₐ, a second peak K_{1b} and a third peak K_{1c} in succession to each other, and the second temperature signal T_{object,2} has a first peak K₂ₐ and a second peak K_{2b} in succession to each other.

The second peak K_{1b} of the first temperature signal T_{object,1} and the first peak K₂ₐ of the second temperature signal T_{object,2} occur in a first time interval Δt₁ which is smaller than the passage time interval (here also indicated by Δtₘₐₓ) and therefore are indicative of a first passage of the person 12 in the monitoring zone 14; the second peak K_{2b} of the second temperature signal T_{object,2} and the third peak K_{1c} of the first temperature signal T_{object,1} occur in a second time interval Δt₂ which is smaller than the passage time interval Δtₘₐₓ and therefore are indicative of a second passage of the person 12 in the monitoring zone 14; and the first peak K₁ₐ of the first temperature signal T_{object,1} is isolated over time with respect to the second temperature signal T_{object,2} (i.e., a corresponding peak of the second temperature signal T_{object,2} within the passage time interval Δtₘₐₓ measured starting from the first peak K_{1b} of the first temperature signal T_{object,1} is not present) and therefore it is not indicative of a complete passage of the person 12 in the monitoring zone 14 (e.g., it may be indicative of the fact that the person enters the monitoring zone 14 at the first field of view 24a but then retraces its steps leaving the monitoring zone 14 without also passing through the second field of view 24b, therefore without completing the passage through the monitoring zone 14). The peaks of the first and the second temperature signals T_{object,1} and T_{object,2} which define a passage of the person 12 in the monitoring zone 14 are also referred to as first signal peak and second signal peak, respectively.

Furthermore, the second peak K_{1b} of the first temperature signal T_{object,1} precedes the first peak K₂ₐ of the second temperature signal T_{object,2} and this is indicative of the passage of the person 12 first through the first field of view 24a and then through the second field of view 24b (therefore of the passage of the person 12 from the first environment 18 to the second environment 19), while the second peak K_{2b} of the second temperature signal T_{object,2} precedes the third peak K_{1c} of the first temperature signal T_{object,1} and this is indicative of the passage of the person 12 first through the second field of view 24b and then through the first field of view 24a (therefore of the passage of the person 12 from the second environment 19 to the first environment 18).

In other words, the relative order of the peaks of the temperature signals T_{object} which define a passage of the person 12 in the monitoring zone 14 is indicative of the direction of passage of the person 12 along the passage direction 30, i.e., it is indicative of whether the person 12 proceeds along a first or along a second passage direction which have axes coincident with each other and with the passage direction 30 and directions opposite to each other. For example, the first passage direction has the axis of the passage direction 30 and the direction which goes from the first environment 18 to the second environment 19 (i.e., from left to right in FIG. 2, in a direction concordant with the axis X) and the second passage direction has the axis of the passage direction 30 and the direction which goes from the second environment 19 to the first environment 18 (i.e., from right to left in FIG. 2, in a direction discordant with the axis X).

The peaks are identified starting from the detection signals (whether they are the temperature signals T_{object} or the motion signals Tₘₒₜᵢₒₙ) in a per se known manner, for example as described in document US20220366768.

In detail, in the case of FIG. 3 wherein the detection signals are the temperature signals T_{object}, the control unit 32 determines that the first and the second temperature signals T_{object,1} and T_{object,2} are indicative of the passage in the monitoring zone 14 (i.e., they have, respectively, the first signal peak and the second signal peak within the passage time interval Δtₘₐₓ) if the first and the second temperature signals T_{object,1} and T_{object,2} have, in succession to each other in the passage time interval Δtₘₐₓ: a rising edge K_{1b}′ of the first temperature signal T_{object,1}, a rising edge K₂ₐ′ of the second temperature signal T_{object,2}, a falling edge K_{1b}″ of the first temperature signal T_{object,1}, and a falling edge K₂ₐ″ of the second temperature signal T_{object,2}; or a rising edge K_{2b}′ of the second temperature signal T_{object,2}, a rising edge Kie′ of the first temperature signal T_{object,1}, a falling edge K_{2b}″ of the second temperature signal T_{object,2} and a falling edge K_{1c}″ of the first temperature signal T_{object,1}. For example, the intervals of the detection signals which increase/decrease seamlessly for a sufficient number of instants consecutive to each other (e.g., for N consecutive samples, with N exemplarily equal to about 30) are considered to be rising/falling edges.

The first case corresponds to the detection in the passage time interval Δtₘₐₓ of the second peak K_{1b} of the first temperature signal T_{object,1} and of the first peak K₂ₐ of the second temperature signal T_{object,2} and therefore it is indicative of the passage of the person 12 along the first passage direction (i.e., from the first environment 18 to the second environment 19), while the second case corresponds to the detection in the passage time interval Δtₘₐₓ of the second peak K_{2b} of the second temperature signal T_{object,2} and of the third peak K_{1c} of the first temperature signal T_{object,1} and therefore it is indicative of the passage of the person 12 along the second passage direction (i.e., from the second environment 19 to the first environment 18).

Conversely, in the case of the first peak K₁ₐ of the first temperature signal T_{object,1}, no corresponding peak is detected in the second temperature signal T_{object,2} within the passage time interval Δtₘₐₓ (i.e., neither of the two successions of previously described rising and falling edges of the temperature signals T_{object} is confirmed) and therefore the control unit 32 does not confirm the detection of the passage in the monitoring zone 14.

The case in which, on the other hand, the first and the second detection signals acquired by the control unit 32 are motion signals Tₘₒₜᵢₒₙ is now described with reference to FIG. 4.

In detail, FIG. 4 shows the trend over time of the motion signals Tₘₒₜᵢₒₙ detected by the first and the second IR radiation sensors 22a and 22b. Hereinafter, the motion signal Tₘₒₜᵢₒₙ detected by the first IR radiation sensor 22a is also called first motion signal T_{motion,1} and the motion signal Tₘₒₜᵢₒₙ detected by the second IR radiation sensor 22b is also called second motion signal T_{motion,2}.

In the example of FIG. 4, the case is exemplarily considered in which two passages of the person 12 in the monitoring zone 14 occur in succession to each other, the first passage relating to the person 12 who transits from the first to the second environment 18, 19 and the second passage relating to the person 12 who transits from the second to the first environment 19, 18.

In greater detail, as time progresses, the first motion signal T_{motion,1} has a first peak M₁ₐ and a second peak M_{1b} in succession to each other, and the second motion signal T_{motion,2} has a first peak M₂ₐ and a second peak M_{2b} in succession to each other.

The first peak M₁ₐ of the first motion signal T_{motion,1} and the first peak M₂ₐ of the second motion signal T_{motion,2} occur in a first time interval Δt₁ which is smaller than the passage time interval Δtₘₐₓ and therefore are indicative of the first passage of the person 12 in the monitoring zone 14; the second peak M_{2b} of the second motion signal T_{motion,2} and the second peak M_{1b} of the first motion signal T_{motion,1} occur in a second time interval Δt₂ which is smaller than the passage time interval Δtₘₐₓ and therefore are indicative of the second passage of the person 12 in the monitoring zone 14. The peaks of the first and the second motion signals T_{motion,1} and T_{motion,2} which define a passage of the person 12 in the monitoring zone 14 are also called first signal peak and second signal peak, respectively.

Furthermore, the first peak M₁ₐ of the first motion signal T_{motion,1} precedes the first peak M₂ₐ of the second motion signal T_{motion,2} and this is indicative of the passage of the person 12 first through the first field of view 24a and then through the second field of view 24b (therefore of the passage of the person 12 from the first environment 18 to the second environment 19), while the second peak M_{2b} of the second motion signal T_{motion,2} precedes the second peak M₂ₐ of the first motion signal T_{motion,1} and this is indicative of the passage of the person 12 first through the second field of view 24b and then through the first field of view 24a (therefore of the passage of the person 12 from the second environment 19 to the first environment 18). In other words, and similarly to what has been previously described, the relative order of the peaks of the motion signals Tₘₒₜᵢₒₙ which define a passage of the person 12 in the monitoring zone 14 is indicative of the direction of passage of the person 12 along the passage direction 30, i.e., it is indicative of whether the person 12 proceeds along the first or along the second passage direction.

In detail, in the case of FIG. 4 wherein the detection signals are the motion signals Tₘₒₜᵢₒₙ, the control unit 32 determines that the first and the second motion signals T_{motion,1} and T_{motion,2} are indicative of the passage in the monitoring zone 14 (i.e., they have, respectively, the first signal peak and the second signal peak within the passage time interval Δtₘₐₓ) if in succession to each other in the passage time interval Δtₘₐₓ: the first motion signal T_{motion,1} goes from a value lower than a switching threshold T_{m,th} to a value higher than the switching threshold T_{m,th}, the second motion signal T_{motion,2} goes from a value lower than the switching threshold T_{m,th} to a value higher than the switching threshold T_{m,th}, the first motion signal T_{motion,1} goes from a value higher than the switching threshold T_{m,th} to a value lower the switching threshold T_{m,th} and the second motion signal T_{motion,2} goes from a value higher than the switching threshold T_{m,th} to a value lower than the switching threshold T_{m,th}; or the second motion signal T_{motion,2} goes from a value lower than the switching threshold T_{m,th} to a value higher the switching threshold T_{m,th}, the first motion signal T_{motion,1} goes from a value lower than switching threshold T_{m,th} to a value higher than the switching threshold T_{m,th}, the second motion signal T_{motion,2} goes from a value higher than the switching threshold T_{m,th} to a value lower than the switching threshold T_{m,th} and the first motion signal T_{motion,1} goes from a value higher than the switching threshold T_{m,th} to a value lower than the switching threshold T_{m,th}.

The first case corresponds to the detection in the passage time interval Δtₘₐₓ of the first peak M₁ₐ of the first motion signal T_{motion,1} and of the first peak M₂ₐ of the second motion signal T_{motion,2} and therefore it is indicative of the passage of the person 12 along the first passage direction (i.e., from the first environment 18 to the second environment 19), while the second case corresponds to the detection in the passage time interval Δtₘₐₓ of the second peak M_{2b} of the second motion signal T_{motion,2} and of the second peak M_{1b} of the first motion signal T_{motion,1} and therefore it is indicative of the passage of the person 12 along the second passage direction (i.e., from the second environment 19 to the first environment 18).

The value of the switching threshold T_{m,th} is chosen in the design step in a per se obvious manner, for example heuristically, as a function of different factors such as the noise of the baseline of the motion signals, the distance of the passage of the person 12 from the IR radiation sensors 22a and 22b, etc. Purely by way of example, the switching threshold T_{m,th} may be equal to about 300 LSB.

In a completely analogous manner, the previous comparison on the basis of the switching threshold T_{m,th} may be performed with hysteresis, so as to increase the reliability of the determination of the passage of the person 12 in the monitoring zone 14 and make the measure more robust. In this case, the condition on the passage of the first and the second motion signals T_{motion,1} and T_{motion,2} from the lower value to the higher value of the switching threshold T_{m,th} occurs as a function of a first switching sub-threshold (correlated to the switching threshold T_{m,th} and, for example, equal to T_{m,th}+ΔTₘ, with ΔTₘ, exemplarily equal to about 10% of the switching threshold T_{m,th} and therefore to about 30 LSB) and the condition on the passage of the first and the second motion signals T_{motion,1} and T_{motion,2} from the higher value to the lower value of the switching threshold T_{m,th} occurs as a function of a second switching sub-threshold (lower than the first switching sub-threshold and correlated to the switching threshold T_{m,th} and for example equal to T_{m,th}−ΔTₘ).

The device 10 may therefore implement in use a method for detecting the passage of the person 12 in the monitoring zone 14.

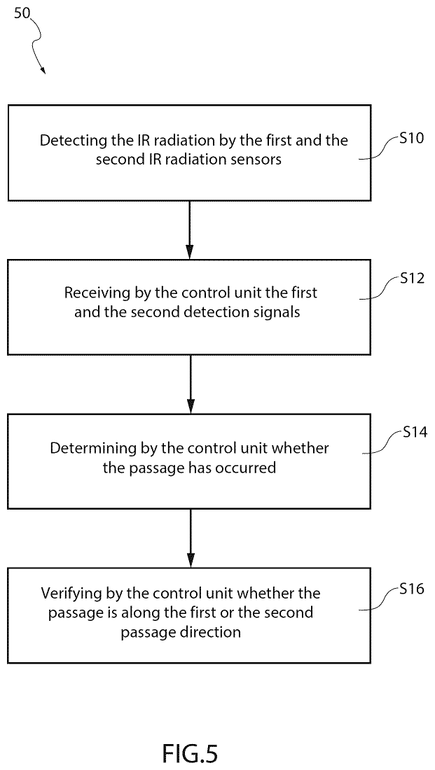

The method is now exemplarily discussed with reference to FIG. 5, where it is indicated with the reference numeral 50.

At a step S10 of the method 50, the first IR radiation sensor 22a detects the IR radiation of the person 12 when he/she is in the first field of view 24a and the second IR radiation sensor 22b detects the IR radiation of the person 12 when he/she is in the second field of view 24b.

At a step S12 consecutive to step S10, the control unit 32 receives the first detection signal from the first IR radiation sensor 22a and the second detection signal from the second IR radiation sensor 22b, wherein the first detection signal is indicative of the presence or absence of the person 12 in the first field of view 24a and the second detection signal is indicative of the presence or absence of the person 12 in the second field of view 24b and the detection signals are generated as a function of the IR radiation detected by the first and the second IR radiation sensor 22a and 22b, respectively.

At a step S14 consecutive to the step S12, the control unit 32 determines, on the basis of the first and the second detection signals, whether the passage of the person 12 in the monitoring zone 14 has occurred. This occurs as previously described, i.e., by verifying whether the first and the second detection signals respectively have the first signal peak and the second signal peak within the passage time interval Δtₘₐₓ and confirming the passage if this condition is verified. In greater detail, this may occur in the two modes previously described with reference to FIGS. 3 and 4.

Furthermore, if the passage of the person 12 in the monitoring zone 14 has been detected, at a step S16, consecutive to step S14, the control unit 32 may verify, on the basis of the first and the second detection signals, whether the passage has occurred along the first passage direction or the second passage direction, as previously described.

From an examination of the characteristics of embodiments made according to the present disclosure, the advantages that they afford are evident.

The device 10 allows the passage of the person 12 in the monitoring zone 14 to be detected effectively, with high accuracy (since it is capable of excluding false positives, as previously described) and with low energy consumption (e.g., of the order of about 40 μA).

In fact, since the IR radiation sensors 22a and 22b are based on TMOS technology and therefore on passive sensors (i.e., which detect the IR radiation emitted by hot bodies without themselves emitting the IR radiation for example according to the time-of-flight mode), have very low energy consumption.

Furthermore, the device 10 is installable in a simpler manner with respect to the known solutions (which for example have exact alignment between the IR radiation emitter and receiver).

Furthermore, the use of two IR radiation sensors 22a and 22b tilted to each other allows not only to detect the passage of the person 12 in the monitoring zone 14, but also the direction in which he/she is walking (i.e., if he/she proceeds along the first or along the second passage direction).

In particular, the use of the first tilting angle α allows to obtain the partial superimposition of the fields of view 24a and 24b (and consequently to achieve this object) by limiting the relative distance between the IR radiation sensors 22a and 22b. This allows the overall dimensions of the device 10 to be reduced.

The device 10 may therefore be effectively used to monitor the number of passages through the monitoring zone 14 and, more generally, to monitor the parameters of the environments 18 and 19 (e.g., count the number of people present in the second environment 19). This allows to respect safety parameters of the environments 18 and 19 (e.g., count the number of people in the second environments 19 to signal any overcrowding) and to control some functionalities of the environments 18 and 19 (e.g., automatic control of lighting or heating according to the presence or absence of people 12 in the second environment 19).

Furthermore, the device 10 may also allow the speed of passage of the person 12 in the monitoring zone 14 to be calculated, for example as a function of the time which elapses between the maxima of the two peaks indicative of the passage and as a function of the distance (known in the design or installation step of the device 10) that the person 12 travels to traverse the monitoring zone 14.

Finally, it is clear that modifications and variations may be made to the various embodiments described and illustrated herein without thereby departing from the scope of the present disclosure. For example, the different embodiments described may be combined with each other so as to provide further solutions.

Although FIG. 1 shows by way of example the embodiment wherein the second environment 19 is a room in a building (e.g., a meeting room), the monitoring zone 14 is comprised in the corridor and the first environment 18 is the outer environment or a different room in the building, and it is evident that other examples may similarly be considered. For example, the second environment 19 may be a building (e.g., a hospital, a stadium, etc.) accessible from the outer environment 18 through an access 16.

Furthermore, the first and the second environments 18, 19 may also be connected to each other through multiple corridors/passageways/doors 16. In this case, each of them has a respective monitoring zone 14 and for each monitoring zone 14 a respective device 10 is present so that the passage of the person 12 from the first environment 18 to the second environment 19 or vice versa through any of these corridors/passageways/doors 16 is detectable by the respective device 10. In other words, if a plurality of corridors/passageways/doors 16 are present, each of them is monitored in such a way that the passage of the person 12 from the first environment 18 to the second environment 19, or vice versa, may still be detected.

Furthermore, although so far reference has been made to a single person 12 transiting between the first and the second environments 18, 19, it is evident that what has been previously described applies in an analogous manner to a plurality of people 12. In this manner the number of people 12 present in the second environment 19 may be monitored, for example in order to control parameters or functionalities of the second environment 19 (e.g., the intensity of the air conditioning flow, etc.).

Furthermore, although so far reference has been made to a person 12 transiting through the monitoring zone 14, what has been previously described applies in an analogous manner to any emitting body which emits infrared radiation (e.g., an animal). Consequently, the person 12 is just one example of any emitting body 12 detectable by the device 10.

A device (10) may be for detecting the passage of an infrared, IR, radiation emitting body (12) in a monitoring zone (14), the device (10) having a first surface (20a) and a second surface (20b) mutually tilted and configured to face the monitoring zone (14). The device (10) may be summarized as including a first IR radiation sensor (22a) extending on the first surface (20a) and a second IR radiation sensor (22b) extending on the second surface (20b), the first IR radiation sensor (22a) being configured to detect the IR radiation of the emitting body (12) when the emitting body (12) is in a first field of view (24a) of the first IR radiation sensor (22a) and the second IR radiation sensor (22b) being configured to detect the IR radiation of the emitting body (12) when the emitting body (12) is in a second field of view (24b) of the second IR radiation sensor (22b), wherein the first (24a) and the second (24b) fields of view are configured to be partially superimposed on each other at the monitoring zone (14).

The first (22a) and the second (22b) IR radiation sensors each include a respective “Thermal MOS,” TMOS, configured to detect the IR radiation emitted by the emitting body (12) respectively in the first (24a) and the second (24b) fields of view.

The first surface (20a) and the second surface (20b) have between each other a first tilting angle (α) between 110° and 170°.

The first (24a) and the second (24b) fields of view have a mutual superimposition region (28) which is smaller than 80% of each of the first (24a) and the second (24b) fields of view.

The device may further include a control unit (32) coupled to the first (22a) and the second (22b) IR radiation sensors and configured to: receive a first detection signal (T_{object,1}; T_{motion,1}) from the first IR radiation sensor (22a) and a second detection signal (T_{object,2}; T_{motion,2}) from the second IR radiation sensor (22b), the first detection signal (T_{object,1}; T_{motion,1}) being indicative of the presence or absence of the emitting body (12) in the first field of view (24a) and the second detection signal (T_{object,2}; T_{motion,2}) being indicative of the presence or absence of the emitting body (12) in the second field of view (24b); and determine, on the basis of the first (T_{object,1}; T_{motion,1}) and the second (T_{object,2}; T_{motion,2}) detection signals, whether the passage of the emitting body (12) in the monitoring zone (14) has occurred.

If the passage of the emitting body (12) in the monitoring zone (14) has been detected, the control unit (32) is further configured to verify, on the basis of the first (T_{object,1}; T_{motion,1}) and the second (T_{object,2}; T_{motion,2}) detection signals, whether the passage of the emitting body (12) in the monitoring zone (14) has occurred along a first passage direction or a second passage direction opposite to each other and extending in the monitoring zone (14).

The first (T_{object,1}; T_{motion,1}) and the second (T_{object,2}; T_{motion,2}) detection signals are respective temperature signals (T_{object}) indicative of the temperature of the emitting body (12), when the emitting body (12) is present respectively in the first (24a) and the second (24b) fields of view, or the first (T_{object,1}; T_{motion,1}) and the second (T_{object,2}; T_{motion,2}) detection signals are respective motion signals (Tₘₒₜᵢₒₙ) indicative of variations over time of respective temperature signals (T_{object}) configured to be generated respectively by the first (22a) and the second (22b) IR radiation sensors and indicative of the temperature of the emitting body (12), when the emitting body (12) is present respectively in the first (24a) and the second (24b) fields of view.

To determine whether the passage of the emitting body (12) in the monitoring zone (14) has occurred, the control unit (32) is configured to: verify whether the first (T_{object,1}; T_{motion,1}) and the second (T_{object,2}; T_{motion,2}) detection signals respectively have a first signal peak and a second signal peak within a passage time interval (Δtₘₐₓ) measured starting from the first of the first signal peak and the second signal peak; and—confirm the passage of the emitting body (12) in the monitoring zone (14) if the first (T_{object,1}; T_{motion,1}) and the second (T_{object,2}; T_{motion,2}) detection signals have the first signal peak and the second signal peak in the passage time interval (Δtₘₐₓ).

If the first (T_{object,1}) and the second (T_{object,2}) detection signals are said respective temperature signals (T_{object}), the control unit (32) is configured to confirm that the first (T_{object,1}) and the second (T_{object,2}) detection signals respectively have the first signal peak and the second signal peak within the passage time interval (Δtₘₐₓ) if the first and the second detection signals have, in succession to each other in the passage time interval (Δtₘₐₓ): a rising edge (K_{1b}′) of the first detection signal (T_{object,1}), a rising edge (K₂ₐ′) of the second detection signal (T_{object,2}), a falling edge (K_{1b}″) of the first detection signal (T_{object,1}) and a falling edge (K₂ₐ″) of the second detection signal (T_{object,2}); or a rising edge (K_{2b}′) of the second detection signal (T_{object,2}), a rising edge (K_{1c}′) of the first detection signal (T_{object,1}), a falling edge (K_{2b}″) of the second detection signal (T_{object,2}) and a falling edge (K_{1c}″) of the first detection signal (T_{object,1}).

If the first (T_{motion,1}) and the second (T_{motion,2}) detection signals are said respective motion signals (Tₘₒₜᵢₒₙ), the control unit (32) is configured to confirm that the first and the second detection signals respectively have the first signal peak and the second signal peak within the passage time interval (Δtₘₐₓ) if, in succession to each other in the passage time interval (Δtₘₐₓ): the first detection signal (T_{motion,1}) goes from a value lower than a switching threshold (T_{m,th}) to a value higher than the switching threshold (T_{m,th}), the second detection signal (T_{motion,2}) goes from a value lower than the switching threshold (T_{m,th}) to a value higher than the switching threshold (T_{m,th}), the first detection signal (T_{motion,1}) goes from a value higher than the switching threshold (T_{m,th}) to a value lower than the switching threshold (T_{m,th}), the second detection signal (T_{motion,2}) goes from a value higher than the switching threshold (T_{m,th}) to a value lower than the switching threshold (T_{m,th}), or the second detection signal (T_{motion,2}) goes from a value lower than a switching threshold (T_{m,th}) to a value higher than the switching threshold (T_{m,th}), the first detection signal (T_{motion,1}) goes from a value lower than the switching threshold (T_{m,th}) to a value higher than the switching threshold (T_{m,th}), the second detection signal (T_{motion,2}) goes from a value higher than the switching threshold (T_{m,th}) to a value lower than the switching threshold (T_{m,th}), the first detection signal (T_{motion,1}) goes from a value higher than the switching threshold (T_{m,th}) to a value lower than the switching threshold (T_{m,th}).

To verify whether the passage of the emitting body (12) in the monitoring zone (14) has occurred along the first passage direction or the second passage direction, the control unit (32) is configured to: verify which of the first signal peak and the second signal peak has been detected first in the passage time interval (Δtₘₐₓ); and—determine that the passage of the emitting body (12) in the monitoring zone (14) has occurred along the first passage direction if the first signal peak precedes the second signal peak in the passage time interval (Δtₘₐₓ), or determine that the passage of the emitting body (12) in the monitoring zone (14) has occurred along the second passage direction if the second signal peak precedes the first signal peak in the passage time interval (Δtₘₐₓ).

A method (50) may be for detecting the passage of an infrared, IR, radiation emitting body (12) in a monitoring zone (14), the method being performed through a device (10) which has a first surface (20a) and a second surface (20b) mutually tilted and configured to face the monitoring zone (14), and comprises a first IR radiation sensor (22a) extending on the first surface (20a), a second IR radiation sensor (22b) extending on the second surface (20b), and a control unit (32) coupled to the first (22a) and the second (22b) IR radiation sensors. The method may be summarized as including the steps of: detecting (S10), by the first IR radiation sensor (22a), the IR radiation of the emitting body (12) when the emitting body (12) is in a first field of view (24a) of the first IR radiation sensor (22a); detecting (S10), by the second IR radiation sensor (22b), the IR radiation of the emitting body (12) when the emitting body (12) is in a second field of view (24b) of the second IR radiation sensor (22b); receiving (S12), by the control unit (32), a first detection signal (T_{object,1}; T_{motion,1}) from the first IR radiation sensor (22a) and a second detection signal (T_{object,2}; T_{motion,2}) from the second IR radiation sensor (22b), the first detection signal (T_{object,1}; T_{motion,1}) being indicative of the presence or absence of the emitting body (12) in the first field of view (24a) and the second detection signal (T_{object,2}; T_{motion,2}) being indicative of the presence or absence of the emitting body (12) in the second field of view (24b), the first (T_{object,1}; T_{motion,1}) and the second (T_{object,2}; T_{motion,2}) detection signals being generated as a function of the IR radiation detected respectively by the first (22a) and the second (22b) IR radiation sensors; and determining (S14), by the control unit (32) and on the basis of the first (T_{object,1}; T_{motion,1}) and the second (T_{object,2}; T_{motion,2}) detection signals, whether the passage of the emitting body (12) in the monitoring zone (14) has occurred, wherein the first (24a) and the second (24b) fields of view are configured to be partially superimposed on each other at the monitoring zone (14).

The method may further include the step of, if the passage of the emitting body (12) in the monitoring zone (14) has been detected, verifying (S16), on the basis of the first (T_{object,1}; T_{motion,1}) and the second (T_{object,2}; T_{motion,2}) detection signals, whether the passage of the emitting body (12) in the monitoring zone (14) has occurred along a first passage direction or a second passage direction opposite to each other and extending in the monitoring zone (14).

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device for detecting a passage of an infrared (IR) radiation emitting body in a monitoring zone, the device comprising:
a first surface;
a second surface, the first surface and the second surface mutually tilted and configured to face the monitoring zone;
a first IR radiation sensor extending on the first surface, the first IR radiation sensor configured to detect the IR radiation of the emitting body when the emitting body is in a first field of view of the first IR radiation sensor; and
a second IR radiation sensor extending on the second surface, the second IR radiation sensor configured to detect the IR radiation of the emitting body when the emitting body is in a second field of view of the second IR radiation sensor, the first and the second field of views are configured to be partially superimposed on each other at the monitoring zone.

2. The device according to claim 1, wherein the first and the second IR radiation sensors each include a respective thermal metal-oxide-semiconductor (TMOS) sensor configured to detect the IR radiation emitted by the emitting body respectively in the first and the second field of views.

3. The device according to claim 1, wherein the first surface and the second surface have between each other a first tilting angle between 110° and 170°.

4. The device according to claim 1, wherein the first and the second field of views have a mutual superimposition region that is smaller than 80% of each of the first and the second field of views.

5. The device according to claim 1, further comprising:
a control unit coupled to the first and the second IR radiation sensors, the control unit configured to:
receive a first detection signal from the first IR radiation sensor, the first detection signal indicating a presence or an absence of the emitting body in the first field of view;
receive a second detection signal from the second IR radiation sensor, the second detection signal indicating a presence or an absence of the emitting body in the second field of view; and
determine, based on the first and the second detection signals, whether the passage of the emitting body in the monitoring zone has occurred.

6. The device according to claim 5, wherein, if the passage of the emitting body in the monitoring zone has been determined to have occurred, the control unit is configured to verify, based on the first and the second detection signals, whether the passage of the emitting body in the monitoring zone has occurred along a first passage direction or a second passage direction opposite to each other and extending in the monitoring zone.

7. The device according to claim 5, wherein the first and the second detection signals are respective temperature signals indicative of a temperature of the emitting body, when the emitting body is present respectively in the first and the second fields of view, or
wherein the first and the second detection signals are respective motion signals indicative of variations over time of respective temperature signals configured to be generated respectively by the first and the second IR radiation sensors and indicative of the temperature of the emitting body, when the emitting body is present respectively in the first and the second fields of view.

8. The device according to claim 5, wherein, to determine whether the passage of the emitting body in the monitoring zone has occurred, the control unit is configured to:
verify whether the first and the second detection signals respectively have a first signal peak and a second signal peak within a passage time interval measured starting from a first of the first signal peak and the second signal peak; and
confirm the passage of the emitting body in the monitoring zone if the first and the second detection signals have the first signal peak and the second signal peak in the passage time interval.

9. The device according to claim 7, wherein, if the first and the second detection signals are the respective temperature signals, the control unit is configured to confirm that the first and the second detection signals respectively have a first signal peak and a second signal peak within a passage time interval measured starting from a first of the first signal peak and the second signal peak if the first and the second detection signals have, in succession to each other in the passage time interval:
a rising edge of the first detection signal, a rising edge of the second detection signal, a falling edge of the first detection signal and a falling edge of the second detection signal; or
a rising edge of the second detection signal, a rising edge of the first detection signal, a falling edge of the second detection signal and a falling edge of the first detection signal.

10. The device according to claim 7, wherein, if the first and the second detection signals are the respective motion signals, the control unit is configured to confirm that the first and the second detection signals respectively have the first signal peak and the second signal peak within a passage time interval measured starting from a first of the first signal peak and the second signal peak if, in succession to each other in the passage time interval:
the first detection signal goes from a value lower than the switching threshold to a value higher than the switching threshold, the second detection signal goes from a value lower than the switching threshold to a value higher than the switching threshold, the first detection signal goes from a value higher than the switching threshold to a value lower than the switching threshold, the second detection signal goes from a value higher than the switching threshold to a value lower than the switching threshold, or
the second detection signal goes from a value lower than a switching threshold to a value higher than the switching threshold, the first detection signal goes from a value lower than the switching threshold to a value higher than the switching threshold, the second detection signal goes from a value higher than the switching threshold to a value lower than the switching threshold, the first detection signal goes from a value higher than the switching threshold to a value lower than the switching threshold.

11. The device according to claim 6, wherein to verify whether the passage of the emitting body in the monitoring zone has occurred along the first passage direction or the second passage direction, the control unit is configured to:
verify which of a first signal peak of the first detection signal and a second signal peak of the second detection signal has been detected first in a passage time interval measured starting from a first of the first signal peak and the second signal peak; and
determine that the passage of the emitting body in the monitoring zone has occurred along the first passage direction if the first signal peak precedes the second signal peak in the passage time interval, or determine that the passage of the emitting body in the monitoring zone has occurred along the second passage direction if the second signal peak precedes the first signal peak in the passage time interval.

12. A method for detecting a passage of an infrared (IR) radiation emitting body in a monitoring zone, the method comprising:
detecting, by a first IR radiation sensor on a first surface of a device, the IR radiation of the emitting body when the emitting body is in a first field of view of the first IR radiation sensor;
detecting, by a second IR radiation sensor on a second surface of the device, the IR radiation of the emitting body when the emitting body is in a second field of view of the second IR radiation sensor, the first surface and the second surface being mutually tilted and configured to face the monitoring zone;
receiving, by a control unit of the device, a first detection signal from the first IR radiation sensor and a second detection signal from the second IR radiation sensor, the first detection signal indicating a presence or an absence of the emitting body in the first field of view, the second detection signal indicating a presence or an absence of the emitting body in the second field of view, the first and the second detection signals being generated as a function of the IR radiation detected respectively by the first and the second IR radiation sensors, the first and the second field of views are configured to be partially superimposed on each other at the monitoring zone; and
determining, by the control unit and based on the first and the second detection signals, whether the passage of the emitting body in the monitoring zone has occurred.

13. The method according to claim 12, further comprising:
if the passage of the emitting body in the monitoring zone has been determined to have occurred, verifying, based on the first and the second detection signals, whether the passage of the emitting body in the monitoring zone has occurred along a first passage direction or a second passage direction opposite to each other and extending in the monitoring zone.

14. The method according to claim 12, wherein the first and the second detection signals are respective temperature signals indicative of a temperature of the emitting body, when the emitting body is present respectively in the first and the second fields of view, or
wherein the first and the second detection signals are respective motion signals indicative of variations over time of respective temperature signals configured to be generated respectively by the first and the second IR radiation sensors and indicative of the temperature of the emitting body, when the emitting body is present respectively in the first and the second fields of view.

15. The method according to claim 12, further comprising:
verifying, by the control unit, whether the first and the second detection signals respectively have a first signal peak and a second signal peak within a passage time interval measured starting from a first of the first signal peak and the second signal peak; and
confirming, by the control unit, the passage of the emitting body in the monitoring zone if the first and the second detection signals have the first signal peak and the second signal peak in the passage time interval.

16. A device comprising:
a first surface facing a monitoring zone;
a second surface facing the monitoring zone;
a first infrared (IR) radiation sensor on the first surface, the first IR radiation sensor having a first field of view, the first IR radiation sensor configured to detect first IR radiation emitted by a body in case the body is in the first field of view;
a second IR radiation sensor on the second surface, the second IR radiation sensor having a second field that partially overlaps with the first field of view, the second IR radiation sensor configured to detect second IR radiation emitted by the body in case the body is in the second field; and
a control unit coupled to the first IR radiation sensor and the second IR radiation sensor, the control unit configured to determine a passage the body through the monitoring zone based on the first IR radiation and the second IR radiation.

17. The device according to claim 16, wherein the first surface and the second surface are surfaces of a substrate, and an angle relative to the first surface and the second surface and extending through the substrate is between 110° and 170°.

18. The device according to claim 16, wherein the first field of view and the second field of view overlap by a that is smaller than 80% of each of the first field of view and the second field of views.

19. The device according to claim 16, wherein the control unit is configured to determine a direction of the passage the body through the monitoring zone based on the first IR radiation and the second IR radiation.
